(19) United States
(12) Patent Application Publication
(10) Pub. No.: US 2008/0247409 A1
(43) Pub. Date: Oct. 9, 2008

(54) Queuing and Scheduling Architecture Using Both Internal and External Packet Memory for Network Appliances

(76) Inventors: Abhijit K. Choudhury, Cupertino, CA (US); Shekhar Ambe, San Jose, CA (US); Himanshu Shukla, Sunnyvale, CA (US); Deepak Mansharamai, San Jose, CA (US); Victor Lin, Fremont, CA (US)

Correspondence Address: PILLSBURY WINTHROP SHAW PITTMAN LLP, P.O. BOX 10500, MCLEAN, VA, 22102, US

(21) Appl. No.: 11/428,965

(22) Filed: Jul. 6, 2006

Related U.S. Application Data
(60) Provisional application No. 60/703,114, filed on Jul. 27, 2005.

(51) Int. Cl. H04L 12/28

(52) U.S. Cl. 370/412

(57) ABSTRACT

Enhanced memory management schemes are presented to extend the flexibility of using either internal or external packet memory within the same network device. In the proposed schemes, the user can choose either static or dynamic schemes, both or which are capable of using both internal and external memory, depending on the deployment scenario and applications. This gives the user flexible choices when building unified wired and wireless networks that are either low-cost or feature-rich, or a combination of both. A method for buffering packets in a network device, and a network device including processing logic capable of performing the method are presented. The method includes initializing a plurality of output queues, determining to which of the plurality of output queues a packet arriving at the network device is destined, storing the packet in one or more buffers, where the one or more buffers is selected from a packet memory group including an internal packet memory and an external packet memory, and enqueuing the one or more buffers to the destined output queue.

### CROSS-REFERENCE TO RELATED APPLICATIONS

This application claims the benefit of priority from U.S. Provisional Patent Application Ser. No. 60/703,114, filed Jul. 27, 2005 and entitled “Queuing and Scheduling Architecture Using Both Internal and External Packet Memory for Network Switching Devices,” which is fully incorporated herein by reference for all purposes.

### BACKGROUND OF THE INVENTION

1. Field of the Invention

Generally, this disclosure relates to network devices. More specifically, it relates to systems and methods associated with queuing and scheduling architecture of network appliances that are capable of supporting wired or wireless clients while using both internal and external packet memory.

2. Description of the Related Art

The Wireless Local Area Network (WLAN) market has experienced rapid growth in recent years, primarily driven by consumer demand for home networking. The next phase of the growth will likely come from the commercial segment comprising enterprises, service provider networks in public places (e.g., Hotspots, etc.), multi-tenant multi-dwelling units (MxUs) and small office home office (SOHO) networks. The worldwide market for the commercial segment is expected to grow from 5M units in 2001 to over 33M units this year, in 2006. However, this growth can be realized only if the issues of security, quality of service (QoS) and user experience are effectively addressed in newer products.

FIG. 1 illustrates an exemplary wired network topology 100 as is known in the art today. As shown in FIG. 1, network 100 can be connected to another external network 110 (e.g., the Internet, an extranet, an intranet, etc.) via a virtual private network (VPN) and/or firewall 115, which can in turn be connected to a backbone router 120. Backbone router 120 can be connected to other network routers 130, 150, as well as one or more servers 125. Router 130 can be connected to one or more servers 135, such as, for example, an email server, a DHCP server, a RADIUS server, and the like. Further, router 130 can be connected to a level2/level3 (L2/L3) switch 140, which can be connected to various wired end user, or wired client, devices 145. Wired client devices 145 can include, for example, personal computers, printers, workstations, scanners, and other similar devices. Router 150 can also be connected to one or more L2/L3 switches 155, 160. Switch 160 can then be connected to one or more wired client devices 165, which can be similar to end user devices 145.

FIG. 2 illustrates an exemplary unified wired and wireless network topology 200 as is known in the art today. Much of this network is as discussed above with reference to FIG. 1. However, additional wired and wireless elements have been added. As additionally shown in FIG. 2, router 155 is connected to wired client devices 258, which can be similar to wired client devices 145, 165. Further, L2/L3 switches 140, 160 are additionally connected to wireless access point (AP) controllers 285, 270, respectively. Each AP controller 285, 270 can be connected to one or more wireless access points 290, 275, respectively. Additional wireless client devices 295, 280 can be wirelessly coupled to wireless APs 290, 275, respectively. Wireless client devices 295, 280, such as desktop computers, laptop computers, personal digital assistants (PDAs), wireless telephones, wireless media players, etc., can connect via wireless protocols such as IEEE 802.11a/b/g/n, IEEE 802.16, and the like to wireless APs 290, 275. More access points can be connected to wireless AP controllers 285, 270. Switches 140, 155, 160 can each be connected to additional wireless access points, access point controllers, and/or other wired and/or wireless network elements such as switches, bridges, routers, computers, servers, and so on. Many possible alternative topologies are possible; as such, FIG. 2 (and FIG. 1) is intended to illuminate, rather than limit, the scope of this disclosure.

Unlike wired networks, as illustrated in FIG. 1, networks that include wireless elements, as in FIG. 2, pose unique challenges, especially in terms of supporting Quality of Service (QoS) for various applications. In a wired enterprise network, packets are typically queued and scheduled using a simple priority-based queuing structure. This is adequate for most applications in terms of service differentiation. However, in wireless networks (i.e., networks that support at least one wireless element), the bandwidth supported to the wireless clients is typically much less than in the wired networks to which the wireless elements are connected. For example, an access point (AP) supports 11 Megabits per second (Mbps) if it is using the IEEE 802.11b protocol and up to 54 Mbps if it is using the IEEE 802.11g protocol. The typical wireless client receives data from the AP using a contention-based protocol, which means they are sharing the available bandwidth. The upstream switch to which the AP controller (and thus the AP) is connected is receiving data at 100 Mbps or even 1 Gigabits per second (Gbps) from its upstream connections for these wireless clients.

A typical implementation of a network device includes a packet memory to store the packets, and queues to organize the packets into an ordered list. Packets arriving at the device are typically stored in the packet memory while they wait to depart on the desired interface. Packets waiting for departure are organized using queues. Packets can be associated with different queues on the same interface, for example, based on their priority or class of service, and different scheduling mechanisms can be used to decide which queue or packet to serve first.

In typical architectures, queues are either implemented as static first-in, first-out (FIFO) queues, or dynamically organized into linked lists. In the former (i.e., FIFO queues), the packet memory is statically partitioned so that specific locations are associated with specific queues. In the latter (i.e., dynamic queues), packet memory locations are associated with different queues at different times based on demand. In conventional systems today, packet memory is implemented either entirely in internal memory or entirely in external memory, and typically never in a combination of the two. Likewise, queues in conventional systems are typically implemented entirely in either internal or external memory. As used herein, internal memory refers to any type of network device traffic storage that is integral to, e.g., on-chip with, the processing logic of the network device and external memory refers to any type of network device traffic storage that is not integral to, e.g., off-chip to, the processing logic.

The use of internal memory can result in a system with higher bandwidth, but the amount of packet buffer integrated on-chip can be limited by chip size and cost. On the other hand, using external memory can provide a large amount of packet storage, but at a lower memory throughput. Typical systems are built using either external or internal memory: external memory when it needs to handle large burst traffic conditions or mismatched link speed, or internal memory when it only needs to handle more ‘normal’ traffic conditions.

In the above mentioned unified network topology, as illustrated in FIG. 2, the wired traffic typically needs small memory storage (e.g., internal memory), while large storage (e.g., external memory) is needed for wireless traffic because of a mismatch in link speeds between ingress and egress links. However, as the wireless traffic is only a subset of the total unified network traffic, the external memory bandwidth requirement can be limited to a much smaller value. Therefore, what is needed is sophisticated queuing and scheduling architecture in a network appliance, such as a unified wired/wireless network device, that can facilitate, among other things, the capability of using both internal memory and external memory for packet memory or queues based on the traffic type.

### SUMMARY OF THE DISCLOSURE

Enhanced memory management schemes are presented to extend the flexibility of using either internal or external packet memory within the same network device. In the proposed schemes, the user can choose either static or dynamic schemes, both or which are capable of using both internal and external memory, depending on the deployment scenario and applications. This gives the user flexible choices when building unified wired and wireless networks that are either low-cost or feature-rich, or a combination of both.

A method for buffering packets in a network device, and a network device including processing logic capable of performing the method are presented. The method includes initializing a plurality of output queues, determining to which of the plurality of output queues a packet arriving at the network device is destined, storing the packet in one or more buffers, where the one or more buffers is selected from a packet memory group including an internal packet memory and an external packet memory, and enqueuing the one or more buffers to the destined output queue.

### BRIEF DESCRIPTION OF THE DRAWINGS

Aspects and features of the present invention will become apparent to those ordinarily skilled in the art from the following detailed description of certain embodiments of the invention in conjunction with the accompanying drawings, wherein:

FIG. 1 illustrates an exemplary wired network topology as is known in the art today;

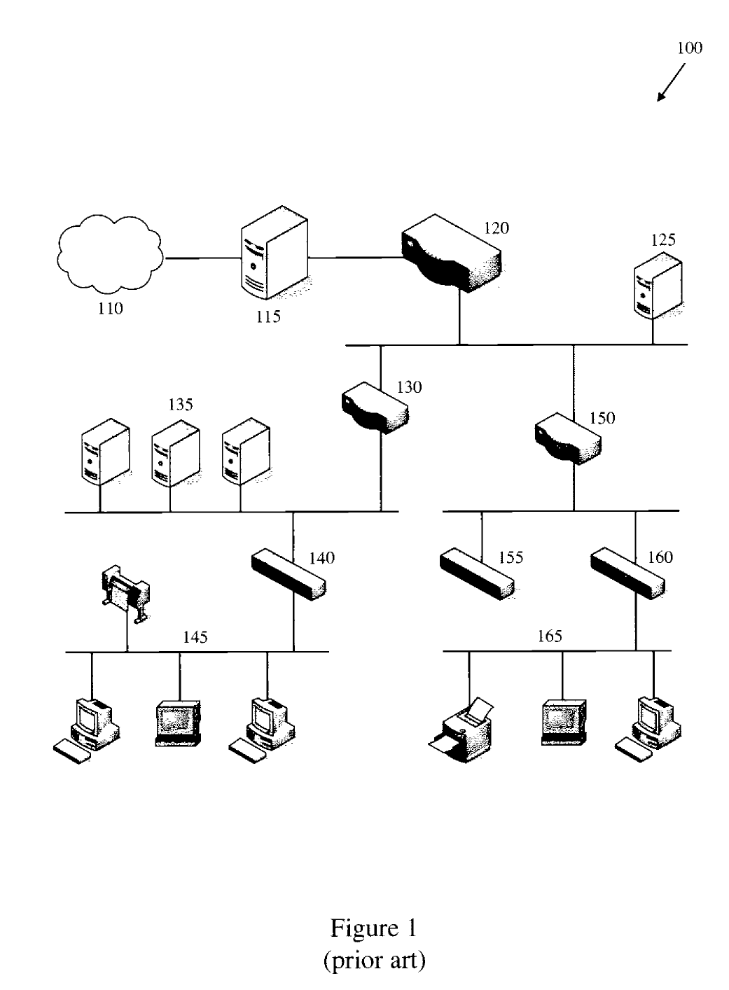

FIG. 2 illustrates an exemplary unified wired and wireless network topology as is known in the art today;

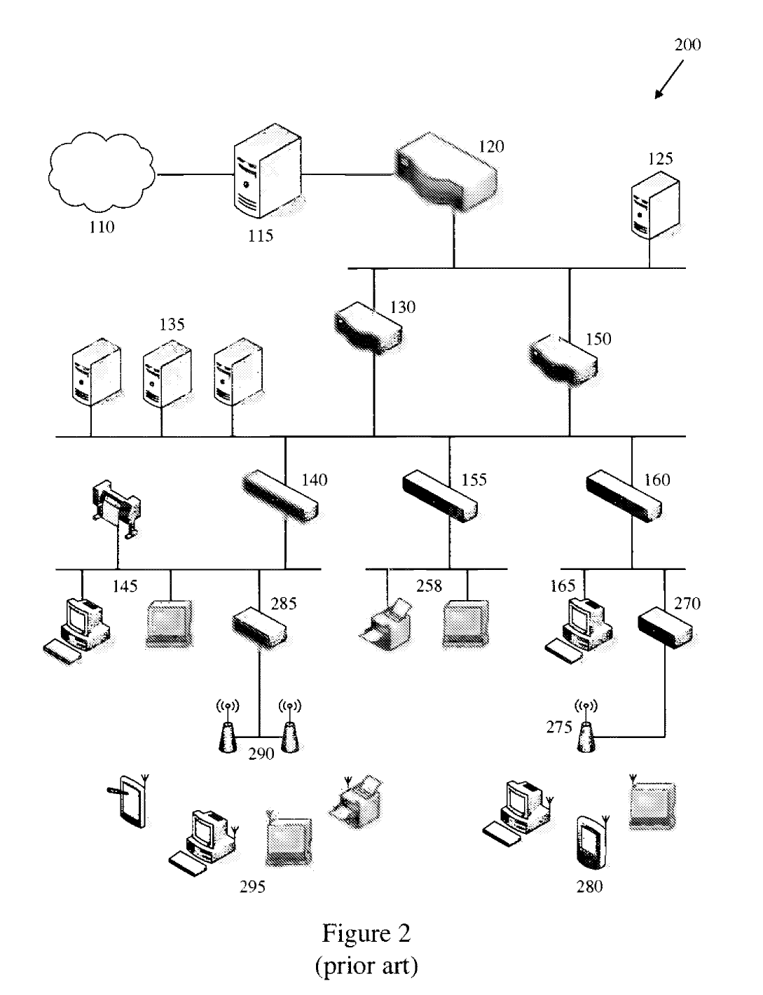

FIG. 3 illustrates an exemplary packet memory according to certain embodiments;

FIG. 4 illustrates an exemplary unicast pointer memory according to certain embodiments;

FIG. 5 illustrates an exemplary multicast pointer memory according to certain embodiments;

FIG. 6 illustrates exemplary queues and queue memory according to certain embodiments;

FIG. 7 illustrates an exemplary static configuration in operation according to certain embodiments; and

FIG. 8 illustrates an exemplary dynamic configuration in operation according to certain embodiments.

### DETAILED DESCRIPTION OF THE INVENTION

Embodiments will now be described in detail with reference to the drawings, which are provided as illustrative examples so as to enable those skilled in the art to practice the embodiments and are not meant to limit the scope of the disclosure. Where aspects of certain embodiments can be partially or fully implemented using known components or steps, only those portions of such known components or steps that are necessary for an understanding of the embodiments will be described, and detailed description of other portions of such known components or steps will be omitted so as not to make the disclosure overly lengthy or unclear. Further, certain embodiments are intended to encompass presently known and future equivalents to the components referred to herein by way of illustration.

In certain embodiments, packet memory can be used to implement a sophisticated, high-performance queuing architecture that can require external packet memory to operate. While the term packet will be used throughout this disclosure to illustrate certain embodiments, it is intended that such embodiments only exemplary, and that the teachings are equally applicable to any type of network traffic, such as datagrams, frames, and other similar data, regardless of the communications layer or layers in which the implementing network device is operating. This typically translates into additional system cost due to the memory chips and circuit board complexity. To reduce this limitation, certain embodiments introduce a novel micro-architecture for the network device that can selectively leverage both on-chip, or internal, packet memory and off-chip, or external, packet memory. Systems can be built according to certain embodiments without external memory to reduce the cost, or with limited external memory to increase performance for a subset of the traffic (e.g., burst traffic, mismatched link speeds, etc.) that may otherwise result in dropped packets if internal memory, when used alone, could not absorb the packets.

According to certain embodiments, there are at least four kinds of memory in the proposed implementation: packet memory, unicast pointer memory, multicast pointer memory, and queues. While the at least four kinds of memory are illustrated herein for completeness, certain embodiments can also be used within a unified device as disclosed in U.S. patent application Ser. No. 11/351,330, filed on Feb. 8, 2006 to Seshan et al. and entitled “Queuing and Scheduling Architecture for a Unified Access Device Supporting Wired and Wireless Clients,” which is fully incorporated herein by reference. Each of the at least four kinds of memory are briefly discussed below.

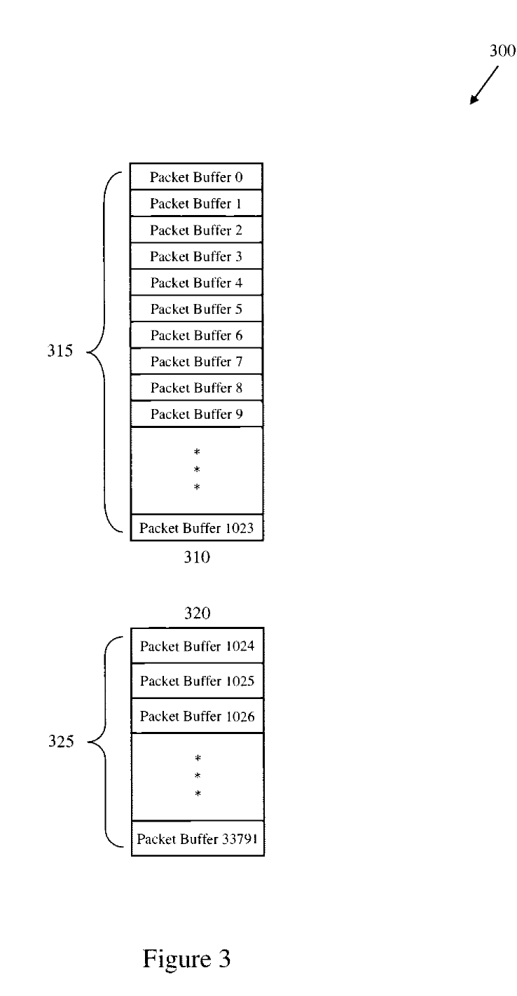

FIG. 3 illustrates an exemplary packet memory 300 according to certain embodiments. As shown in FIG. 3, packet memory 300 can be both internal memory 310 and/or external memory 320. Internal packet memory 310 can be, for example, on-chip memory of a type and size as design constraints dictate. External packet memory 320 can be, for example, off-chip memory of a type and size as design constraints dictate. Internal and external packet memories 310, 320 can be used to store buffered packets 315, 325, respectively. Packet memory 300 can be divided into large fixed-size buffers that are big enough to hold the maximum sized packets (e.g., 1500 bytes for each TCP/IP datagram); or it can be divided into smaller buffer cells (e.g. 128 bytes each) so that a packet is stored in multiple cells that can be chained together. In general, the packet-based packet memory architecture is simpler, but the cell-based packet memory architecture can potentially use memory more efficiently. Certain embodiments are equally applicable to both (or either) packet-based architecture and cell-based architecture.

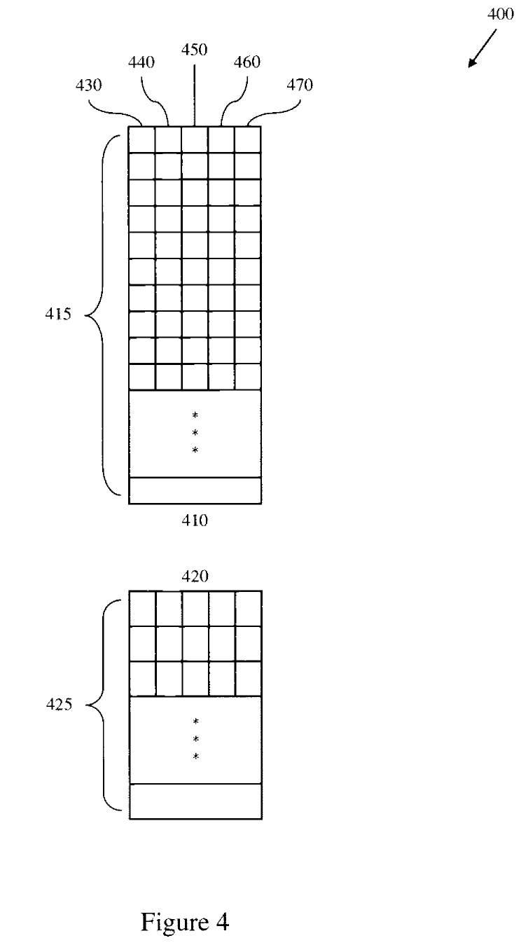

FIG. 4 illustrates an exemplary unicast pointer memory 400 according to certain embodiments. As shown in FIG. 4, unicast pointer memory 400 is memory, which can be similar to packet memory 300 and also can include internal memory 410 and/or external memory 420, can be used to describe the content of packet memory locations 415, 425. It also can contain pointers to chain packets together to form a queue. Each internal and external packet memory block 315, 325 can be associated with an internal and external unicast pointer memory 415, 425, respectively. Unicast pointer memory can additionally include the following information (i.e., one or more bits each): next pointer type 430, count info 440, length info 450, ingress port info 460 and next pointer 470. Next pointer type 430 can indicate whether the next pointer points to a multicast pointer, in the multicast pointer memory, or another unicast pointer, in the unicast pointer memory. Count info 440 can indicate the replication count for associated data in the packet memory. For multicast packets, count info 440 can indicate the number of multicast pointers that point to this particular packet pointer. Length info 450 can indicate the size of the packet. Ingress port info 460 can indicate from where the associated packet came. Next pointer info 470 can point to either the next unicast pointer or multicast pointer, depending on next pointer type 430. Next pointer info 470 can point to itself, for example, if there are no packets behind the current packet associate with current next pointer info 470.

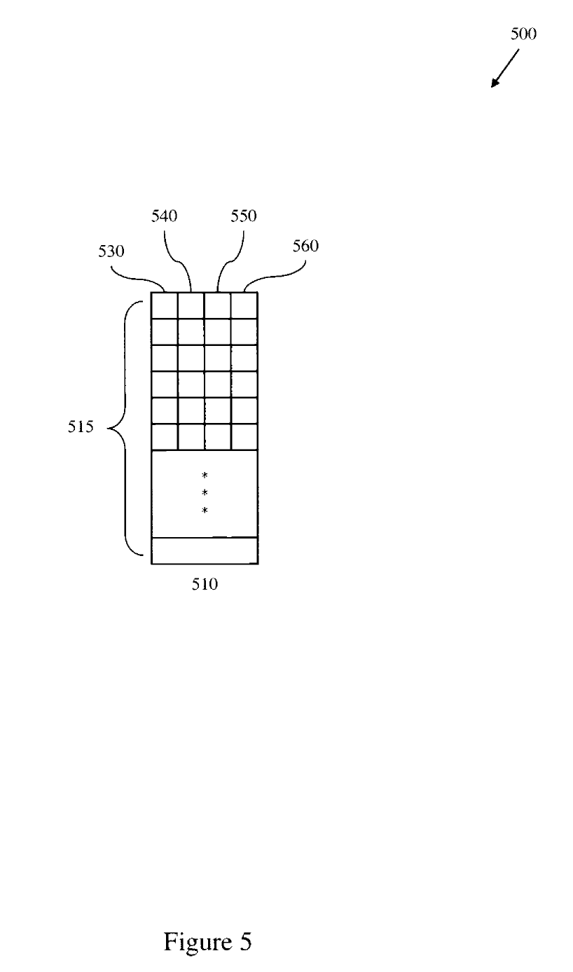

FIG. 5 illustrates an exemplary multicast pointer memory 500 according to certain embodiments. As shown in FIG. 5, multicast pointer memory 500 is a piece of internal and/or external memory that can be used to chain multicast packets, as indicated by next pointer type 430 from unicast pointer memory 400, into a queue. Multicast pointer memory 500 can have a buffer pointer 550 that points to the unicast pointer memory that is associated with where the actual multicast packet is stored. Similar to unicast pointer memory 400, multicast pointer memory 500 can also have multicast info 530, count 540 and next pointer 560, which allows it to point to the next packet in the queue.

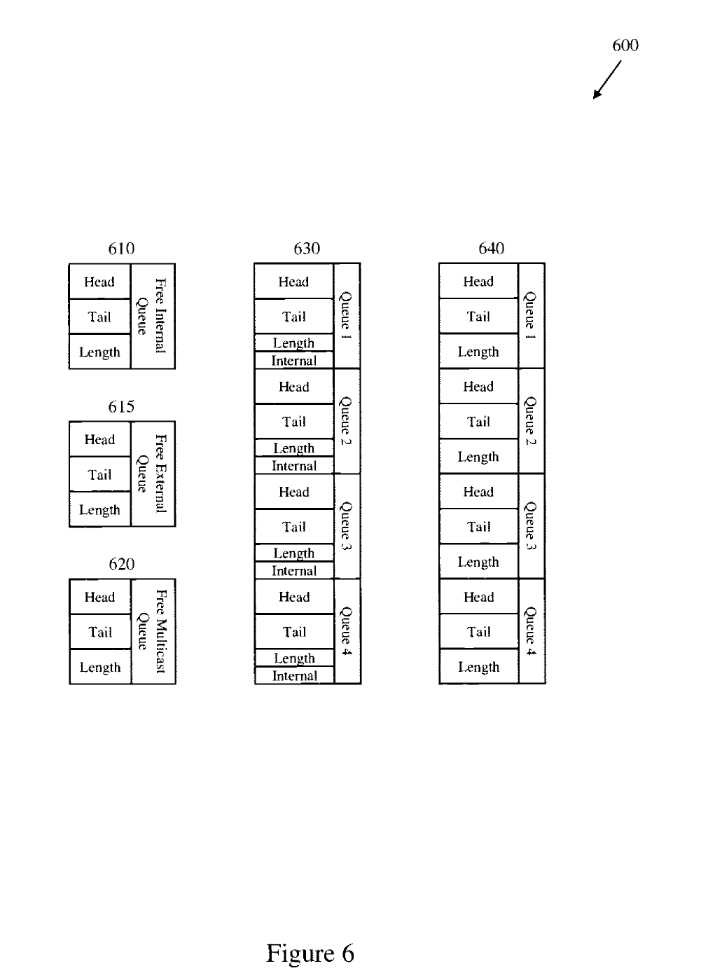

FIG. 6 illustrates exemplary queues and queue memory 600 according to certain embodiments. As shown in FIG. 6, each queue, generally, can have one or more of the following pieces of information (i.e., one or more bits each): queue ID, queue head, queue tail, queue length and internal/external indicator. Queue ID identifies the particular queue. Queue head is a pointer that points to the first packet of the queue, with the multicast bit to indicate whether the first packet in the queue is a multicast or unicast packet. Queue tail is a pointer that points to the last packet of the queue. The queue length field records the number of packets in the queue. Internal/external indicator provides whether a particular queue uses internal or external memory. Besides the egress queues 630, 640, there can be other special queues: free internal queue 610, free external queue 615 and free multicast queue 620. Free internal/external queues 610, 615, respectively, can maintain a list of unused unicast pointers (e.g., internal or external) and free multicast queue 620 can maintain a list of unused multicast pointers.

According to certain embodiments, two broad categories of configurations are disclosed to facilitate the use of internal and external packet memory in a network device: a static configuration and a dynamic configuration, which are not necessarily mutually exclusive of each other. Further, within each of these two broad categories, there are at least three kinds of queues: internal queues, external queues and aggregate queues. For an internal queue, all associated packet memory is internal memory, while for an external, all associated packet memory is external memory. However, for an aggregate queue, the associated packet memory can be both internal and external packet memory.

Generally, in a static configuration according to certain embodiments, each output queue can be pre-configured, or designated, for example during the initialization process, to be an internal queue, an external queue or an aggregate queue. Alternatively, to build a static system without external memory, all queues would be programmed to use internal memory. If external memory is available, a user can assign queues to use either internal memory, external memory or both, depending on the operational needs of the network device implementing the static configuration. For example, all of the output queues associated with wired traffic might be assigned to use internal memory, while queues handling wireless traffic could use external memory to facilitate buffering packets because of mismatched link speeds. Further, for handling multicast traffic or mirrored traffic, the aggregate queues could be used.

Generally, in a dynamic configuration according to certain embodiments, all of the output queues can be configured to dynamically and selectively use and alternate between both internal and external packet memory. For these queues, if both types of packet memory are available, internal memory can be used first. If there is no internal memory available, either because it does not exist of because it is currently full, external memory can be used. In this regard, external memory can serve as an “overflow buffer” during, for example, a burst-traffic condition. During a normal-traffic condition, all packets destined to dynamic queues can use internal memory.

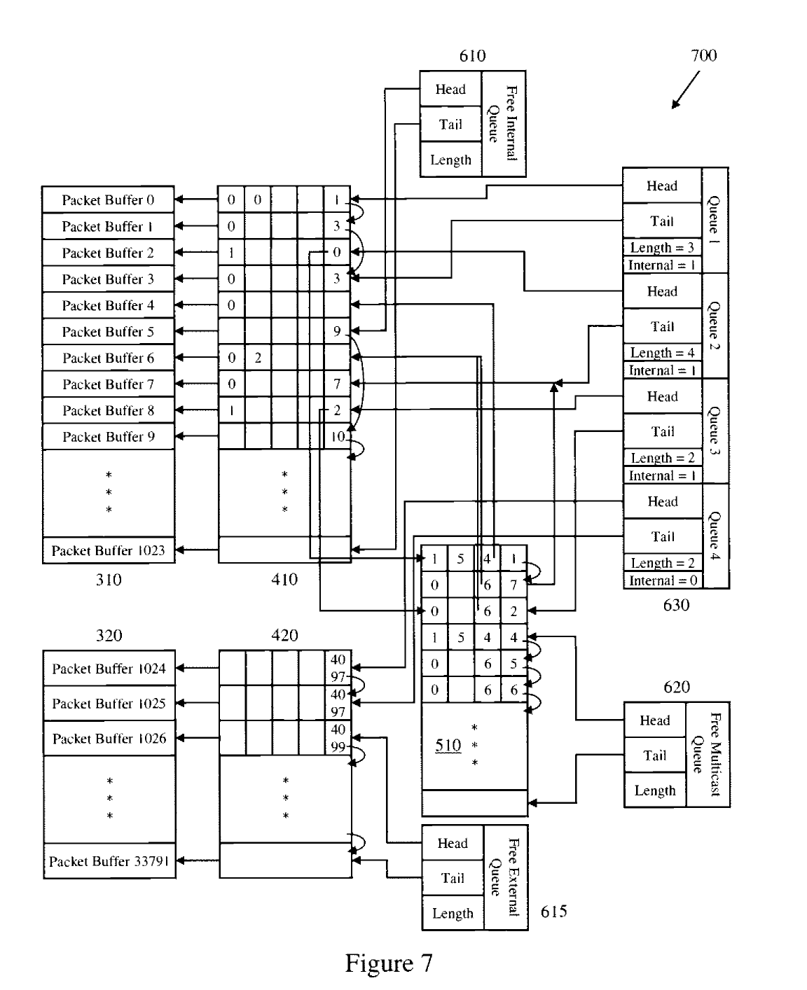

FIG. 7 illustrates an exemplary static configuration 700 in operation according to certain embodiments. As shown in FIG. 7, the exemplary elements described above in relation to FIGS. 3-6 are interactively linked. Unicast packet pointers 410 (i.e., pointers 0 to 1023) can be used in conjunction with internal packet memory 310, and unicast packet pointers 410 (i.e., pointers 1024 to 33791) can be used for external memory. There are two free buffer queues, one for internal memory 610 and one for external memory 615. In certain embodiments, each queue can have one or more bits indicating whether internal, external or both should be used for a particular egress queue 630. If the internal/external indicator is set as internal, then this internal queue should use internal memory. If the internal indicator/external is set as external, then this external queue should use external memory. If the internal/external indicator is set for both, then this aggregate queue can use both, or either, internal and external memory.

For certain embodiments of the static configuration, three exemplary implementation schemes are presented. The use of one particular scheme over another depends on system requirements. In the first scheme, each physical port of the implementing network device can have two packet buffers, one internal 310 and one external 320, that are allocated and waiting for incoming packets. Internal packet buffer 310 is allocated from internal free queue 610 and external packet buffer 320 comes from external packet queue 615. Those packet buffers can serve as temporary storage for incoming packets while they are processed by the ingress pipeline of the network device. During the packet reception phase, each incoming packet can be stored in both internal and external packet buffer at the same time. The packet can be enqueued to egress queue once the forwarding decision is made by the ingress pipeline. Alternatively, for systems with only one type of packet memory (e.g., internal or external), all queues (and multicast memory) should be initialized to use that memory type.

In the above mentioned scheme, each packet can be stored both in internal memory and external memory. Once the information about the outgoing queue (i.e. internal, external, etc.) is available, then depending on the queue configuration, either the internal or external buffer can be discarded. For packets destined to internal queue the packet is stored both in internal and external memory. For these packets the bandwidth needed to write a packet to the external memory is wasted. Hence, the above scheme works best, but not exclusively, if the bandwidth to external memory is not limited as compared to the internal bandwidth.

In the second exemplary static configuration scheme, if the information about the destination queue is available before the packet data arrives, then the first exemplary scheme can be modified to store the packet directly into an internal or external buffer. In this way, the implementing network device can function even with very limited external memory. But this scheme does not handle the scenario where a burst of packets should be stored in the external memory as efficiently as the first scheme.

To handle the above drawbacks the following, third exemplary static configuration scheme can be used. A transfer queue consisting of a small number of internal packet buffers can be maintained. Each physical port of the implementing network device can have an internal packet buffers that is allocated and waiting for incoming packets. These packet buffers can serve as temporary storage for incoming packets as they are processed by the ingress pipeline of the network device. Based on packet forwarding logic or packet classification, the ingress pipeline can determine the appropriate egress queue. In case the egress queue is configured as an internal queue (i.e. the packets for this queue should be stored in the internal memory) the packet buffer can be directly linked to the egress queue. However, if the packet is destined for an external queue, then the packet buffer is first linked to the transfer queue. The packets are then transferred from the transfer queue to external memory, which is then linked to the egress queue.

For multicast and broadcast packets in each of these three exemplary static configuration schemes, the packet buffer needs to be enqueued to multiple queues. These queues can be configured internal, external or aggregate queues. If the outgoing queue 630 is configured to use internal memory, then the internal packet buffer 310 will be enqueued to the output queue. If the outgoing queue 630 is configured to use external memory, then external packet memory 320 will be enqueued to the output queue. In this exemplary static configuration, a multicast packet may consume two or more packet buffers if the multicast includes output queues using both internal and external packet memories 310, 320.

An alternative approach for handling multicast and broadcast packets would be through the use of aggregate queues. Here each multicast cast group or the broadcast group can be designated as internal or external. Thus, the multiple multicast or broadcast groups can be mapped to the same aggregate queue. If the group is set to internal then internal packet buffer 310 can be used, otherwise external packet memory 320 can be used for the group. In this way, only one copy of the multicast packet would need to be stored. As a simplification of this, all multicast and broadcast groups can be designated as internal or external.

Packets which are mirrored or copied can also be enqueued to multiple queues. The queue designated for forwarding the packet is referred to as a forwarding queue. If these queues are configured as either internal or external then as mentioned above either the internal or external packet buffer 310, 320 is used. An alternate mechanism would be to assign aggregate queues for mirrored or copied packets. Here the packet can be enqueued using the internal or external buffer based on the forwarding queue configuration.

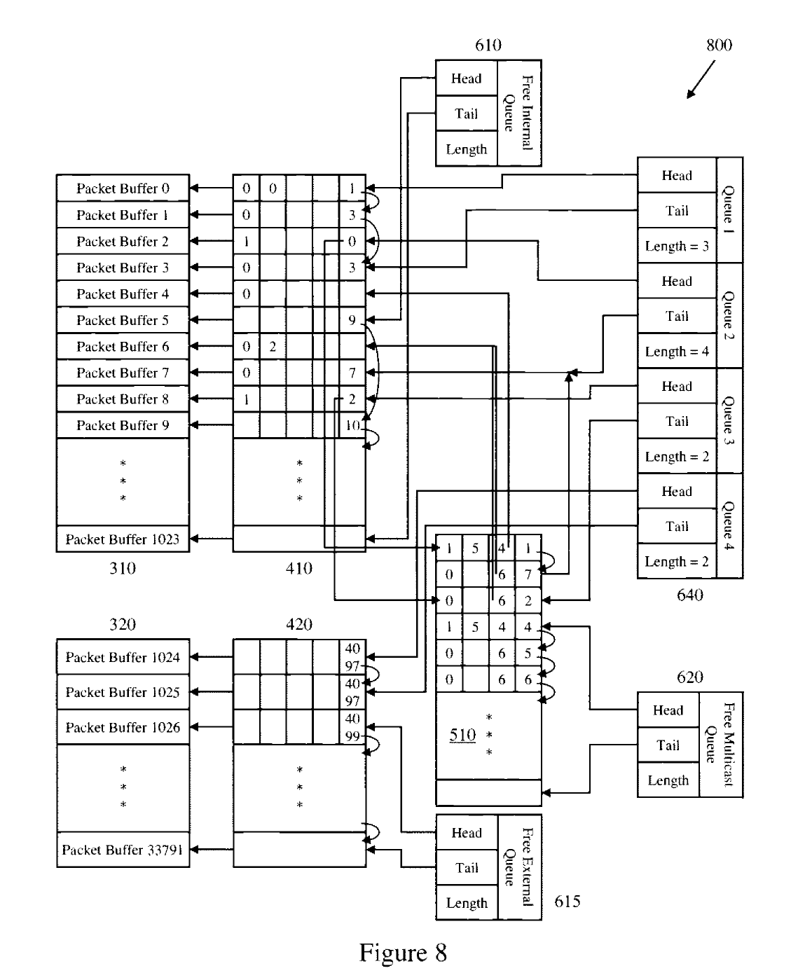

FIG. 8 illustrates an exemplary dynamic configuration 800 in operation according to certain embodiments. As shown in FIG. 8, the exemplary dynamic configuration generally operates the same as previously discussed in relation to FIG. 7, especially in relation to similarly labeled components, with the following exception: instead of statically assigning all queues to a particular buffer type, at least some queues can be dynamic queues. In this way a dynamic queue can be considered a queue property, and not necessarily a port property. In one possible implementation, it is assumed that buffers in the internal memory 310 will be used before buffers in the external memory 320. Thus, output queues 640 no longer require the internal info that was included with output queues 630 of FIG. 7. But as previously discussed, other schemes for dynamic configuration are intended to be within the scope of this disclosure.

For dynamic configuration, similar to static configuration discussed above, multicast or broadcast packets should be enqueued on multiple queues. It is possible that one of the queues can be designated dynamic, while other queues are designated internal. In such a situation, the multicast or broadcast packet can be, for example, preferably stored in the internal memory. However, in cases where all queues are dynamic, then the packet can be stored using either internal or external packet buffer based on system design. For example, a particular implementation could store these packets in external memory if the number of packets for any of the output queues is beyond some configured value. The decision to choose internal or external buffer could also be based on some predetermined configuration. However, if in a system it is possible that multiple dynamic queues would be full at the same time and the external memory bandwidth would not be sufficient to handle the burst traffic, then the transfer queue mechanism described above for static configuration can be used. These same implementations can be followed in the case of mirrored packets and/or copied packets.

In certain embodiments, both static and dynamic configurations can be applied to cell-based packet memory architecture. In cell-based packet memory architecture, a packet is stored in one or multiple memory cells. A cell can be physically located in either internal or external memory and a packet can be stored across multiple cells of both memory types. In a static configuration, each port of the network appliance should allocate to multiple cells, large enough to hold a single packet from either or both internal and external packet memory. A packet can be stored in either internal cells or external cells, depending on the outgoing queue. In a dynamic configuration, if there are not enough free internal memory cells to store an entire packet, external memory can be used so that a single packet need not be stored in a mix of internal and external cells. However, mixed storage can be accomplished using the cell-based packet memory architecture according to certain embodiments.

Although the present invention has been particularly described with reference to embodiments thereof, it should be readily apparent to those of ordinary skill in the art that various changes, modifications, substitutes and deletions are intended within the form and details thereof, without departing from the spirit and scope of the invention. Accordingly, it will be appreciated that in numerous instances some features of the invention will be employed without a corresponding use of other features. Further, those skilled in the art will understand that variations can be made in the number and arrangement of inventive elements illustrated and described in the above figures. It is intended that the scope of the appended claims include such changes and modifications.

What is claimed is:

1. A method for buffering data in a network device, the method comprising the steps of:
initializing a plurality of output queues;
determining to which of the plurality of output queues data arriving at the network device is destined;
storing the data in one or more buffers, wherein the one or more buffers is selected from a data memory group including an internal data memory and an external data memory; and
enqueuing the one or more buffers to the destined output queue.

2. The method of claim 1, wherein:
the plurality of output queues are initialized by associating at least one output queue with the internal data memory and at least another output queue with the external data memory; and
the data is stored according to a static queuing scheme.

3. The method of claim 2, wherein the static queuing scheme includes:
storing the data in the one or more buffers of the data memory group to which the destined output queue is associated.

4. The method of claim 2, wherein the static queuing scheme includes:
storing the data in both an internal data memory location and an external data memory location; and
purging the data from the storage location to which the destined output queue is not associated.

5. The method of claim 2, wherein the static queuing scheme includes:
storing the data in only one of an internal data memory location and an external data memory location; and
moving the data from the storage location to which the destined output queue is associated if the destined output queue is associated with a different storage location.

6. The method of claim 2, wherein the static queuing scheme includes:
storing the data in an internal data memory location; and
moving the data from the internal data memory location to an external data memory location if the destined output queue is associated with the external data memory location.

7. The method of claim 2, wherein:
the data belongs to a class of datas, the class of datas including a multicast data, a broadcast data, a unicast data that is mirrored to at least two output queues, and a unicast data that is copied between at least two output queues;
the destined output queue includes the at least two queues; and
the one or more buffers includes at least one storage instance.

8. The method of claim 7, where in the plurality of output queues includes one or more of an internal queue, an external queue and an aggregate queue.

9. The method of claim 1, wherein:
the plurality of output queues are initialized to be capable of selectively choosing between the internal data memory and the external data memory;
the data is stored according to a dynamic queuing scheme.

10. The method of claim 9, wherein the dynamic queuing scheme includes, if both the internal data memory and the external data memory are available, choosing the internal data memory first and the external data memory second.

11. The method of claim 9, wherein the dynamic queuing scheme includes, if only one of the internal data memory and the external data memory is available, choosing the one available.

12. The method of claim 9, where in the plurality of output queues includes one or more of an internal queue, an external queue and an aggregate queue.

13. The method of claim 1, wherein the data memory is partitioned into a plurality of full-size data buffers.

14. The method of claim 1, wherein the data memory is partitioned into a plurality of cell-based buffers, each of a size less than a full-sized data.

15. The method of claim 14, wherein the one or more buffers includes at least two of the plurality of cell-based buffers.

16. A network device, the device comprising processing logic, wherein the processing logic is capable of:
initializing a plurality of output queues;
determining to which of the plurality of output queues a data arriving at the network device is destined;
storing the data in one or more buffers, wherein the one or more buffers is selected from a data memory group including an internal data memory and an external data memory; and
enqueuing the one or more buffers to the destined output queue.

17. The device of claim 16, wherein:
the plurality of output queues are initialized by associating at least one output queue with the internal data memory and at least another output queue with the external data memory; and
the data is stored according to a static queuing scheme.

18. The device of claim 17, wherein the static queuing scheme includes:
storing the data in the one or more buffers of the data memory group to which the destined output queue is associated.

19. The device of claim 17, wherein the static queuing scheme includes:
storing the data in both an internal data memory location and an external data memory location; and
purging the data from the storage location to which the destined output queue is not associated.

20. The device of claim 17, wherein the static queuing scheme includes:
storing the data in only one of an internal data memory location and an external data memory location; and
moving the data from the storage location to which the destined output queue is associated if the destined output queue is associated with a different storage location.

21. The device of claim 17, wherein:
the data belongs to a class of datas, the class of datas including a multicast data, a broadcast data, a unicast data that is mirrored to at least two output queues, and a unicast data that is copied between at least two output queues;
the destined output queue includes the at least two queues; and
the one or more buffers includes at least one storage instance.

22. The device of claim 21, where in the plurality of output queues includes one or more of an internal queue, an external queue and an aggregate queue.

23. The device of claim 16, wherein:
the plurality of output queues are initialized to be capable of selectively choosing between the internal data memory and the external data memory;
the data is stored according to a dynamic queuing scheme.

24. The device of claim 23, wherein the dynamic queuing scheme includes, if both the internal data memory and the external data memory are available, choosing the internal data memory first and the external data memory second.

25. The device of claim 23, wherein the dynamic queuing scheme includes, if only one of the internal data memory and the external data memory is available, choosing the one available.

26. The device of claim 23, where in the plurality of output queues includes one or more of an internal queue, an external queue and an aggregate queue.

27. The device of claim 16, wherein the data memory is partitioned into a plurality of full-size data buffers.

28. The device of claim 16, wherein the data memory is partitioned into a plurality of cell-based buffers, each of a size less than a full-sized data.

29. The device of claim 28, wherein the one or more buffers includes at least two of the plurality of cell-based buffers.
